(19) United States
(12) Patent Application Publication
(10) Pub. No.: US 2012/0045547 A1
(43) Pub. Date: Feb. 23, 2012

(54) Functional Fruits and Vegetables Bean Curd without Salt Water and Method for Preparing the Same

(76) Inventor: Chang Whan Kim, Seoul (KR)

(21) Appl. No.: 12/857,788

(22) Filed: Aug. 17, 2010

(51) Int. Cl. A23L 1/20

(52) U.S. Cl. 426/46; 426/634

(57) ABSTRACT

Disclosed is a functional fruits and vegetables bean curd without salt water, and a method for preparing the same, in which the method has advantages that a low digestibility caused from the processing of the existing beans, and the problem regarding the salt water or salt contained in the bean curd can be basically improved by using the germinated soybean sprouts and the fermentation aging solution, and the bean curd having the rich fermentation metabolites that have greatly increased nutrient component and functional component as well as the nutrient of the soybean can be manufactured.

### TECHNICAL FIELD

The present invention relates to a functional fruits and vegetables bean curd without salt water, and a method for preparing the same.

### BACKGROUND ART

A bean is effective in preventing many kinds of cancer, in preventing an osteoporosis by the effect of an isoflavone, in suppressing diabetes, in preventing a high blood pressure, in decreasing cholesterol and in preventing a heart disease, by the effect of a bean protein, in preventing an aging of brain by the effect of a rich vitamin E, and in treating obesity by the effect of saponin.

Especially, add an additional explanation regarding the effect of isoflavone, many kinds of isoflavone, such as genistein and daidzein, and derivatives thereof are existed in a bean. The isoflavone is also called as vegetable estrogen, because isoflavone is similar in function to estrogen that is hormone in the body. In other words, when the body is deficient in estrogen due to menopause, it is the principle that osteoporosis due to the lack of estrogen can be prevented by injecting the vegetable estrogen because the vegetable estrogen performs a similar role to estrogen in the body.

As set forth above, a bean having a useful effect on the body as mentioned above is ingested through processed various foods, and a representative processing food may be a bean curd.

Generally, a bean curd is being widely used as a traditional processed food in Korea, until now and typically a method for preparing a bean curd includes boiling a bean juice produced by grinding a soaked bean in a cauldron, and the like, and then coagulating with salt water.

However, the technology for preparing the bean curd is already known, and the key technology for preparing the bean curd is a coagulation technology, because a quality of the bean curd depends largely on the coagulation process.

Therefore, the bean curd produced by using salt water is being sold on the market, and also the unrefined salt is in general use in a considerable number of many households, so that it is reasonable to assume that the amount of magnesium ion that is ingested by Korean people is considerable. Of course, it is thought that the amount of magnesium ion ingested by ingesting the bean curd is few because the amount of the residual magnesium ion in the bean curd is few. However, in the case of Korean people who use the traditional Korean sauces produced by using fermented soybean lumps, and the like, in which the fermented soybean lumps are foods protecting Korean health, adult disease are caused by ingesting an excess amount of magnesium ion considering the amount of magnesium contained in the fermented soybean lumps.

### DISCLOSURE

### Technical Problem

Accordingly, the inventers finished the present invention by confirming a new bean curd and a method for preparing the same, in which the new bean curd uses a nutrient of soy bean, has its own flavor, a soft texture, and simultaneosly a flexible texutre, during processing the research to be solved the problem regarding contained salt or salt water, and low coefficient digestibility in the existing method for processing a bean, and to simply and quickly manufacture a bean curd without a coagulant used in the exisiting method for preparing a bead curd.

An object of the present invention is to provide a functional fruits and vegetables bean curd without salt water and a method for preparing the same, in which the functional fruits and vegetables bean curd uses a nutrient of soy bean, which includes lots of bioactive substances, such as a type of isoflavone, a phytosterol, a lecithin, a saponin, which have the functions of anticancer and antioxidant, and fermentation metabolites in the bean curd are rich by using fermentation aging solution that is added with powder or extracts of fruits and vegetables and have functionality of intestinal regulation of lactic acid bacteria.

### Technical Solution

The present invention provides a functional fruits and vegetables bean curd without salt water, and a method for preparing the same, by using a fermentation aging solution that is added with powder or extracts of fruits and vegetables.

The method for preparing the fruits and vegetables bean curd according to the present invention uses soybean sprouts.

The method for preparing the fruits and vegetables bean curd according to the present invention uses a fermentation aging solution that is added with powder or extracts of the fruits and vegetables, and the fermentation aging solution is fermented by inoculating a composite strain to vegetables sprouts fermentaiton aging solution.

Hereinafter, the present invention will be described in detail.

The present invention provides the method for preparing the fruits and vegetables bean curd without salt water including the following steps:
a) grinding germinated soybean sprouts to separate soybean milk;
b) adding a fermentation aging solution added with powder or extracts of the fruits and vegetables after sterilizing the separated soybean milk;
c) coagulating the soybean milk added with the fruits and vegetables; and
d) pressing the coagulated soybean milk to prepare the bean curd.

The present invention provides the functional fruits and vegetable bean curd without salt water prepared by the method as mentioned above.

For the present invention, the germinated soybean sprouts in the step a) are germinated for 3 to 7 days by putting the swollen bean that is soaked in water for 2 to 4 hours into a typical cultivation vessel for sprouts and cultivating for 2 to 5 days, or spreading the swollen beans to a hexagon plate, watering in every 0.5 to 2 hours, and circulating air.

At this process, for keeping the beans soaked in water, when soaking for less than 2 hours, an efficiency for germinating sprouts is decreased; on the contary, when soaking for at least 4 hours, the efficiency for germinating is increased, but the sprouts can be budding before cultivating. When the cultivation period exceeds the above period within the range of 32 to 33° C. that is the optimum temperature of germinating soybean, the sprouts are excessively grown, thereby decreasing the content of the active substances; on the contrary, when the cultivation period is less than above period, the germination rate of sprouts is low.

For the present invention, the fermentation aging solution in the step b) is prepared by inoculating the composite strain to the fermentation aging solution of sprouts vegetables, and fermenting for 20 to 40 hours at 20 to 40° C.

The fermentation aging solution of sprouts vegetables is fermented for aging by mixing at least one or two selected from the group consisting of broccoli sprouts, alfalfa sprouts, a raphanus sativus, buckwheat sprouts, wheat sprouts, tatsoi sprouts, and bok choy sprouts. More specifically, an extract is concentrated by mixing 100 parts by weight of sprouts vegetables with 40 to 70 parts by weight of water in an extractor, and hydrothermally extracting for 8 to 12 hours at 120 to 130° C. This is why in the case that the extraction time is less than 8 hours within the range of the above temperature, available components are not extracted, and in the case that the extraction time exceeds 12 hours, the available components may be destroyed.

Unnecessary residue as a solid state of sprouts vegetables, such as a fiber, is removed by pressing and filtering the concentrated hydrothermal extract to yield a filtrate.

For the present invention, the composite strain is at least two selected from the group consisting of Leuconostoc Kimchii, Leuconostoc citreum, Leuconostoc mesenteroides, Leuconostoc gasicomitatum, Leuconostoc lactis, Lactobacillus plantarum, and Lactobacillus sakei.

In the present invention, a production of a fermenation coagulant that can well coagulate a soybean protein is important. Further, a fermentation bacteria fermenting the produced bean curd should be able to ferment for having a good texture without off flavor when fermentating the bean curd, and also should be able to produce lots of the fermentation metabolites.

The composite lactic acid bacteria is important for producing the fermentation coagulant that can well coagulate the soybean protein. This is why the composite lactic acid bacteria can produce the rich fermentation product by removing a fermentation flavor through a mutual supplementation because each kind of the lactic acid bacteria has a different fermentation mechanism. Specifically, for example, for the difference of fermentation mechanism, even if the lactic acid belongs in the same class, when growing using glucose, there is a lactic acid bacteria, such as Streptococcus, which mainly produce a lactic acid, there is the lactic acid bacteria, such as Leuconostoc, which produce an ethanol and a carbon dioxide, in addition to the lactic acid, and there is also the lactic acid bacteria, such as Bifidobacterium, which produce the lactic acid and an acetic acid.

Further, an immune system is activated by all sorts of hydrololytic enzyme, 1th and 2nd metabolites, a material in the bacteria, and the like, derived from the bacteria as mentioned above. And also the growth in an intestine of a harmful bacteria, such as salmonella, E-coil, and the like, which produce diarrhea, can be suppressed by a natural antibiotic substance, such as bacteriocin, diacetyl, and the lactic acid.

The fermentation aging solution is produced by inoculating the composite strain to the mixed solution that mixes the produced fermentation aging solution of sprouts vegetables and a carrot extract at a weight rate of 1:0.5 to 2, and fermenting for 20 to 40 hours at 20 to 40° C.

The fermentation aging solution is the one to break down the soybean protein into a peptide type having a low molecular weight. The fermentation aging solution includes lots of all sorts of high functional materials, has an excellent digestion and absorption ability. Even if the lactic acid bacteria can acidify the fermentate because the lactic acid bacteria secretes the lactic acid and decreases pH when growing, the lactic acid bacteria has an advantage that it can produce the antibiotic material suppressing basically the growth or germination of microorganism spore as a similar species, and secure the advantageous circumstance for itself, and also give the scent and the flavor of the fermentation food.

For the present invention, the step c) is characterized by coagulating with the addition of a fruit juice or a fruit vinegar. More specifically, the step c) is the step for coagulating for 2 to 7 hours at 20 to 40° C. by injecting the fermentation aging solution, and the fruit juice or fruit vinegar after the step b). The coagulation time and temperature are very important because the lactic acid bacteria starts to die over 50° C., and nearly dies out by 80° C., and, if the lactic acid bacteria is left at a temperature of 20 to 40° C. for a long time, the activity of the lactic acid bacteria is increased, thereby growing a sour taste.

For the present invention, the fruit juice is a citron juice, a schizandra juice, a plum juice, a lemon juice, an apple juice, or an orange juice, and the furit vinegar is a persimmon vinegar, a plum vinegar, an apple vinegar, or a grape vinegar.

The fruit juice produced by grinding, extracting, and filtering of the fruits can be used as the fruit juice as mentioned above. Preferably, the concentrated fruit juice as a concentrated type can be used by evaporating water by heating the fruit juice as mentioned above, and the citron juice is preferably used.

The fruit juice is a material that includes a carbon source as a sugar material. In the case that the fermentate is produced by only using the fermentation aging solution of sprouts vegetables, the content of carbon source that can be used by the composite strain is in short supply. Therefore, for the present invention, it is important that an insufficient carbon source can be supplied by adding the fruit juice.

Further, the additional component, i.e., the fruit juice, along with the lactic acid bacteria are added in the coagulation step, so that the addition of the fruit juice relieves the sour taste of the bean curd obtained, in which the sour taste is caused by the lactic acid bacteria, and also sweet taste obtained from the additional fruit juice relieves the sour taste generated from the lactic acid bacteria.

The present invention is characteristic of preparing the fruits and vegetables bean curd by adding 5 to 20 parts by weight of the fermentation aging solution and 0.5 to 10 parts by weight of the fruit juice or the fruit vinegar, based on 100 parts by weight of the soybean.

In the case that less than 5 parts by weight of the fermentation aging solution is added to the fruits and vegetables bean curd, the coagulation of the bean curd does not well occur; on the contrary, in the case that the additional content of the fermentation aging solution exceeds 20 parts by weight, the coagulation of the bean curd well occur, but there is a problem that the bean curd has a old flavor. Further, in the case that less than 0.5 parts by weight of the fruit juice or the fruit vinegar is added, the soybean protein cannot be degraded into the peptide type having a low molecular weight because of the lack of the carbon sources content, so that the object of the present invention cannot be achieved. In the case that the fruit juice or the fruit vinegar exceeds 10 parts by weight, there is a disadvantage that the bean curd does not have itself flavors by the acidification of the fermentate by decreasing pH.

For the present invention, the bean curd is manufactured by pressing the coagulated soybean after c) step.

The method for preparing the fruits and vegetables bean curd according to the present invention is economical due to the effects of reducing of the process, because the method does not have an inconvenient process for removing the extra coagulant by soaking the bean curd obtained for a while in water after pressing by using a pressing molder after covering the bean curd that is finished the coagulation with a cloth in the typical method for preparing the bean curd.

### Advantageous Effects

As described above, the method for preparing the functional fruits and vegetables bean curd has advantages that a low digestibility caused from the processing of the existing beans, and the problem regarding the salt water or salt contained in the bean curd can be basically improved by using the germinated soybean sprouts and the fermentation aging solution, and the bean curd having the rich fermentation metabolites that have greatly increased nutrient component and functional component as well as the nutrient of the soybean can be manufactured.

Korean people have problem that associated high intake of salt or magnesium from the traditional Korean sauces, such as a red pepper paste or a soybean paste as the major basic foods. Therefore, there are advantages that the fruits and vegetables bean curd according to the present invention can make to minimize the amount of salt or magnesium that is excessively ingested, and has soft and flexible flavors that has greatly increased the functional components and the nutrient components.

### BEST MODE

Hereinafter, the present invention will be described in more detail with reference to the following Examples. However, the following Examples are just to help for understand the present invention, and the scope of the present invention is not limited to the following Examples.

At this time, technology terms and science terms have meanings that the those who skilled in the art can generally understand, it there are not any other meanings, and the known functions and configurations that can make to not clear the points of the following description and the attached figures are not provided.

### EXAMPLE

(1) Preparation of Fermentation Aging Solution

Each 100 g of broccoli sprouts, alfalfa sprouts, a raphanus sativus, buckwheat sprouts, wheat sprouts, tatsoi sprouts, and bok choy sprouts were washed with a purified water, shaken out to remove water, dried in the shade, and then mixed evenly. 700 g unrefined sugar was mixed with the mixed sprouts vegetables as mentioned above, put into an earthen pot, and then pressed with a wide and flat stone that was sterized in boiling water. And then the top of the earthen pot was covered with the hanji, and then tided up with a rubber band. After making three needle holes on the top, the fermentation was performed for one week in the summer time, and for two weeks in the winter time. After the fermentation, the solution obtained from squeezing was collected by squeezing and then removing a sediment, and then placed in the earthen pot. After covering the top of the earthen pot with the hanji, the earthen pot was placed in a cold place for aging during about 100 days to manufacture 300 ml of the fermentation aging solution of sprouts vegetables.

Harvested carrot 10 kg and water 5 l were put into an extractor that was able to cold circulate with a cold water, and then a hydrothermol extraction was performed was during maintaining for 12 hours at a temperature of 120° C. to concentrate the extraction. And, the concentrate was filtered with a filter to remove a fiber of a solid type and other impurites, and yield a filtrate separately thereby preparing a carrot extract.

The fermentation aging solution was prepared by inoculating kimchi lactic acid bacteria, Leuconostoc mesenteroides IMSNU 10146, and Leuconostoc gasicomitatum KCTC 3753 to the mixture of the obtained fermentation aging solution of sprouts vegetables and the obtained carrot extract at the rate of 1:1, and cultivating thereof. At this time, pH of the fermenation aging solution was 3.5.

(2) Preparation of Bean Curd

After the beans were soaked in water for 4 hours, put into a net and then put into a cultivation box, the temperature of water was set at 32˜33° C., and then the beans was cultivated for 3 days for germinating. The germinated soybean sprouts were grinded, the grinded soybeans were separated into a bean curd dregs and soybean milk by using a centrifuger, and then the separated soybean milk was heated at 100° C. for 1 hour, and then cooled.

The fermentation aging solution 10 wt % obtained from the (1) and the citron juice 0.1 wt % were added to the cooled soybean milk, agitated at 35° C., and then coagulated for 4 hours.

After coagulating, the coagulated curd removed from the coagulation vessel was covered with a cloth, the coagulated curd covered with the cloth was pressed with 2 kg/cm² pressing force by using the pressing molder. The cloth covering the curd was removed, cooled with a cold water, sterized in a hot water, and then packed. The packed curd was stored in a cold storage.

### Comparative Example

Comparative Example uses the same method in Example, except that the soybean protein was coagulated by adding 0.4% concentration of calcium chloride solution based on the soybean milk, instead of the fermentation aging solution and the coagulant.

### Test Example 1

For the fruits and vegetables bean curd prepared in the Example, a hardness, a cohesiveness, an elasticity, an adhesiveness, a chewiness, and a gumminess of the bean curd were measured with a texturometer (TA-XT2i)

TABLE 1

| | Hard- | Cohe- | Elas- | Adhe- | Chewi- | Gummi- |
|---|---|---|---|---|---|---|
| | ness | siveness | ticity | sivenss | ness | ness |
| Example | 217.1 | 0.609 | 0.976 | 289.9 | 144.0 | 148.2 |
| Comparative | 183.6 | 0.449 | 0.952 | 104.7 | 70.8 | 80.0 |
| example | | | | | | |
| General | 141.2 | 0.530 | 0.936 | 114.9 | 67.4 | 98.6 |
| bean curd | | | | | | |
| (product | | | | | | |
| availavle | | | | | | |
| from P | | | | | | |
| company | | | | | | |

As shown in the above results of Table 1, it could be confirmed that properties of the bean curd, such as the hardness, the cohesiveness, the elasticity, the chewiness, and the gumminess were excellent, as compared to the bean curds in Comparative Example, as a control, and the general bean curds in the market (product available from P company).

### Test Example 2

As compared to Comparative Example and the general bean curd in the market (product available from P company), the bean curd prepared in Example were estimated targeting total 70 people men and women (men23/women17) from 10 to 70 years old. And the results were shown in the following Table 2.

TABLE 2

| | Preference | | |
|---|---|---|---|
| | | | General bean curd |
| | | Comparative | (product availavle |
| Category | EXample | example | from P company |
| Total rate | 70% (49 persons) | 19% (13 persons) | 10% (7 persons) |

Further, a sensory evaluation, such as a flavor, a scent, a soft, and a digestive power regarding the fruits and vegetables bean curd prepared in the Example was carried out as a ten-point rating, and the results were shown in the following Table 3. At this time, a grade means that the more the number, the number of grade increases, the level of satisfaction is of great value.

TABLE 3

| | Sensory evaluation item | | | |
|---|---|---|---|---|
| | | | | Digestive |
| | Flavor | Scent | Soft | power |
| Sensory | 9.0 | 9.2 | 8.9 | 9.1 |
| evaluation | | | | |
| grade | | | | |

As shown in the above results of Table 3, it could be confirmed that the high level of satisfaction regarding the digestive power and soft texture was found, as well as the high level of interest regarding the flavor and the scent.

### Test Example 3

The nutrient components of the fruits and vegetables bean curd prepared in Example were compared in each other, and the results were shown in the following Table 4.

TABLE 4

| | Example | Comparative example |
|---|---|---|
| Vitamin D | 0.017 | 0.001 |
| Folic acid | 0.3 | 0 |
| Gaba | 4.2 | 0.3 |
| Free amino acid | 950 | 310 |

As shown in the above results of Table 4, it could be confirmed that the fruits and vegetables bean curd had more nutrient components rather than that of the bean curd that is prepared by adding calcium chloride solution in Comparative Example, and also a vitamin D and folic acid was produced during the method for preparing the fruits and vegetables bean curd.

1. A method for preparing functional fruits and vegetables without salt water, comprising:
a) grinding germinated soybean sprouts to separate soybean milk;
b) adding a fermentation aging solution added with powder or extracts of the fruits and vegetables after sterilizing the separated soybean milk;
c) coagulating the soybean milk added with the fruits and vegetables; and
d) pressing the coagulated soybean milk to prepare the bean curd.

2. The method for preparing the functional fruits and vegetables without salt water of claim 1, wherein the germinated soybean sprouts in the grinding of the germinated soybean sprouts to separate soybean milk are germinated for 3 to 7 days by putting the swollen bean that is soaked in water for 2 to 4 hours into a typical cultivation vessel for sprouts and cultivating for 2 to 5 days, or spreading the swollen beans to a hexagon plate, watering in every 0.5 to 2 hours, and circulating air.

3. The method for preparing the functional fruits and vegetables without salt water of claim 1, wherein the fermentation aging solution in the adding of the fermentation aging solution added with powder or extracts of the fruits and vegetables after sterilizing the separated soybean milk is prepared by inoculating the composite strain to the fermentation aging solution of sprouts vegetables, and fermenting for 20 to 40 hours at 20 to 40° C.

4. The method for preparing the functional fruits and vegetables without salt water of claim 3, wherein the fermentation aging solution of sprouts vegetables is fermented for aging by mixing at least one or two selected from the group consisting of broccoli sprouts, alfalfa sprouts, a raphanus sativus, buckwheat sprouts, wheat sprouts, tatsoi sprouts, and bok Choy sprouts.

5. The method for preparing the functional fruits and vegetables without salt water of claim 3, wherein the composite strain is at least two selected from the group consisting of Leuconostoc Kimchii, Leuconostoc citreum, Leuconostoc mesenteroides, Leuconostoc gasicomitatum, Leuconostoc lactis, Lactobacillus plantarum, and Lactobacillus sakei.

6. The method for preparing the functional fruits and vegetables without salt water of claim 1, wherein the coagulation by adding a fruit juice or a fruit vinegar is carried out in the coagulating of the soybean milk added with the fruits and vegetables.

7. The method for preparing the functional fruits and vegetables without salt water of claim 6, wherein the fruit juice is a citron juice, a schizandra juice, a plum juice, a lemon juice, an apple juice, or an orange juice, and the fruit vinegar is a persimmon vinegar, a plum vinegar, an apple vinegar, or a grape vinegar.

8. The method for preparing the functional fruits and vegetables without salt water of claim 1, wherein the fruits and vegetables bean curd is prepared by adding 5 to 20 parts by weight of the fermentation aging solution and 0.5 to 10 parts by weight of the fruit juice or the fruit vinegar, based on 100 parts by weight of the soybean.

9. A fruits and vegetables bean curd prepared by using the method according to claim 1.
